(19) United States
(12) Patent Application Publication
(10) Pub. No.: US 2025/0170901 A1
(43) Pub. Date: May 29, 2025

(54) ROLLING DEVICE WITH MIXED FRICTION/MAGNETIC BRAKING, AND AIRCRAFT THUS EQUIPPED

(71) Applicant: SAFRAN LANDING SYSTEMS, VELIZY VILLACOUBLAY (FR)

(72) Inventors: Graeme Peter Arthur KLIM, MOISSY-CRAMAYEL (FR); Lucas Fernand Jean-Marie SANTER, MOISSY-CRAMAYEL (FR); Duy-Minh NGUYEN, MOISSY-CRAMAYEL (FR)

(21) Appl. No.: 18/843,104

(22) PCT Filed: Mar. 2, 2023
(86) PCT No.: PCT/EP2023/055368

§ 371 Date: Aug. 30, 2024

(30) Foreign Application Priority Data
Mar. 2, 2022 (FR) 2201833

(51) Int. Cl. B60L 7/24; B60L 7/28; B60T 13/74; B64C 25/44

(52) U.S. Cl. CPC B60L 7/24; B60L 7/28; B60T 13/74; B64C 25/44

(57) ABSTRACT

A rolling device for a vehicle, having a wheel rim pivoting about a shaft and delimiting two recesses, one receiving a friction braking device and the other a magnetic braking device having a stator constrained to rotate with the shaft, a rotor constrained to rotate with the wheel, and a control member of the magnetic braking de-vice extending at least partially into the shaft. An aircraft having such a rolling device.

The present invention relates to the field of braking for vehicle wheels such as aircraft wheels.

### BACKGROUND OF THE INVENTION

An aircraft wheel generally comprises a rim linked by a disc to a hub mounted so as to rotate on a shaft (axle or spindle) secured to one end of a landing gear.

Friction braking devices are known comprising a stack of brake discs that is housed in a space extending between the rim and the hub and that comprises an alternation of rotor discs constrained to rotate with the wheel and stator discs that are fixed in relation to the wheel support shaft. The braking device also comprises hydraulic or electromechanical actuators mounted on an actuator carrier and arranged to apply a controlled braking force to the stack of discs in such a way as to brake the rotation of the wheel.

Equipping such braked wheels with an electromagnetic auxiliary brake that dissipates energy by means other than mechanical friction has been proposed, in particular in document FR-A-2953196. However, the free space at the wheel is extremely limited, complicating the operation of installing an auxiliary brake.

Also known are magnetic braking devices referred to as eddy current magnetic braking devices, or eddy current brakes, which are used for the brakes of vehicles wheels and, more particularly, aircraft wheels. Within the meaning of this application, a magnetic braking device is a device dedicated to braking, and not a motor used as a generator for regenerative braking. Document WO-A-2014/029962 describes such a device comprising a stator that is provided with one or more magnets and is mounted facing an electrically conductive rotor. Document US-A-20200300310 also describes an eddy current magnetic braking device.

The performances of an eddy current magnetic braking device generally depends on the power and dimensions of the magnets used. The braking device is therefore relatively heavy and bulky when high maximum braking power is required. That is the case, for example, for use on an aeroplane, where weight and space requirement are severe constraints.

### OBJECT OF THE INVENTION

The aim of the invention is, in particular, to propose a rolling device that offers improved braking performance while maintaining a reasonable space requirement.

### SUMMARY OF THE INVENTION

To this end, according to the invention, a rolling device for a vehicle is provided, comprising a leg provided with a shaft and a wheel having a hub mounted to pivot on the shaft. The wheel comprises a rim that is linked to the hub by a disc to extend coaxially with the hub. The rim comprises a first annular portion that protrudes from the disc and facing the hub, delimiting therewith a first annular recess having one end closed by the disc and one end that opens towards the leg to receive a friction braking device. The rim comprises a second annular portion protruding from the disc opposite the first annular portion, delimiting a second recess having one end closed by the disc and an opposite open end. A magnetic braking device is mounted in the second recess, and comprises:
a first element and a second element that has a surface facing a surface of the first element and is able to rotate in relation to the first element, one of the first or second element being constrained to rotate with the shaft and one of the first or second element being constrained to rotate with the wheel; and
a control member of the magnetic braking device extending at least partially into the shaft.

This arrangement helps limit the space requirement of the wheel by at least partially incorporating the magnetic braking device into it. It is therefore possible to provide both friction braking and magnetic braking in a wheel whose space requirement remains reasonable for most applications that may be envisaged, in particular those in which the rolling device needs to be stowed in a hold of the vehicle when not in use. Incorporating part of a magnetic brake into the wheel also helps to limit the drag generated by the magnetic brake. A wheel is therefore provided that has two separate integrated braking devices, providing particular efficient braking in a relatively small space.

The invention also relates to an aircraft equipped with at least one such rolling device.

Other features and advantages of the invention will become apparent on reading the following description of particular and non-limiting embodiments of the invention.

### BRIEF DESCRIPTION OF THE DRAWINGS

Reference will be made to the accompanying drawings, in which:

FIG. 1 is a partial schematic view of an aircraft equipped with rolling devices according to the invention;

FIG. 2 is a partial schematic view of a rolling device according to a first embodiment of the invention, in axial half section, with the stator of the magnetic brake in the braking position;

FIG. 3 is a view similar to that of FIG. 2 of this rolling device with the stator of the magnetic brake in a freely rotating position;

FIG. 4 is a logic diagram showing the different operating modes of the magnetic braking device depending on the operating phases of the aircraft;

FIG. 5 is a view similar to that of FIG. 2 of a rolling device according to a first variant of the first embodiment;

FIG. 6 is a view similar to that of FIG. 2 of a rolling device according to a second variant of the first embodiment;

FIG. 7 is a partial schematic view of a rolling device according to a second embodiment of the invention, in axial half section, with the stator of the magnetic brake in the braking position;

FIG. 8 is a view similar to that of FIG. 7 of this rolling device with the stator of the magnetic brake in a freely rotating position;

FIG. 9 is a partial schematic view of a rolling device according to a third embodiment of the invention, in axial section, with the stator of the magnetic brake in the braking position;

FIG. 10 is a view similar to that of FIG. 9 of this rolling device with the stator of the magnetic brake in a freely rotating position; and

FIG. 11 is a partial schematic view, along the axis of rotation of the wheel, of the arrangement of the magnets on the stator.

### DETAILED DESCRIPTION OF THE INVENTION

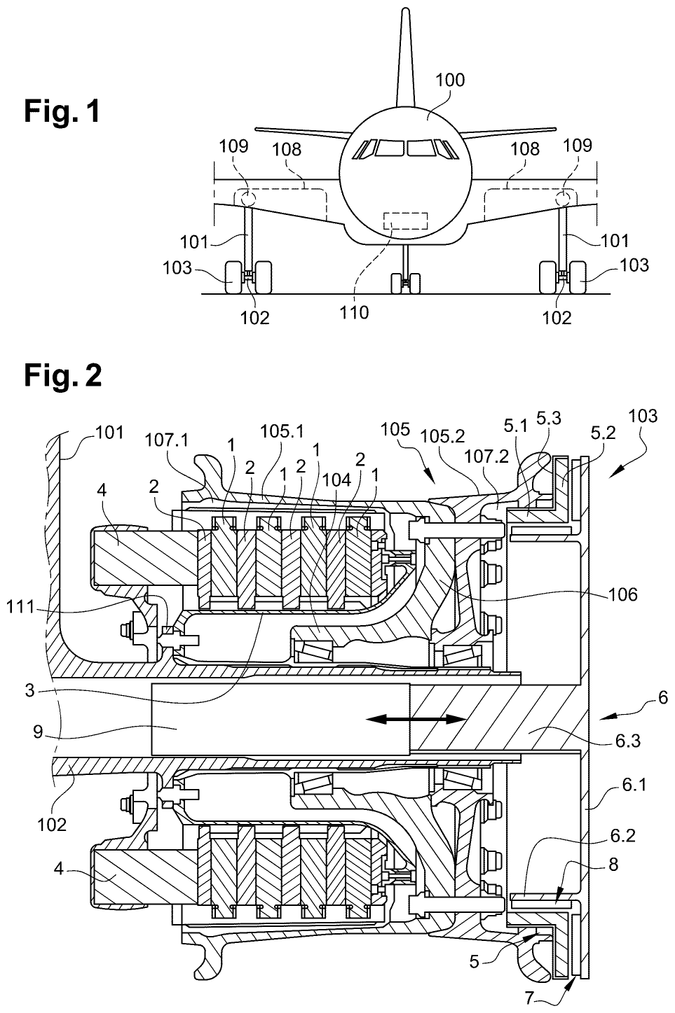

In reference to FIGS. 1 to 3, the first embodiment of the invention is described in application to an aircraft 100 comprising rolling devices each forming a landing gear mounted on the structure of the aircraft to pivot between a deployed position (shown in FIG. 1) and a position stowed in a hold 108 under the action of a landing gear actuator 109 that is known per se and connected to an electronic control unit 110. Each landing gear comprises a leg 101 having one end provided with two coaxial shafts 102, on each of which a wheel 103 is mounted so as to pivot. In a manner that is known per se, each wheel 103 comprises a hub 104 mounted to pivot on the shaft 102 and a rim 105 that is linked to the hub 104 by a disc 106 and that has two annular flanks between which a tyre is accommodated. The two shafts 102 are made from a single piece, hollow and have an external surface supporting the bearings guiding the hub 104 of each wheel 103 in rotation about the central axis of the shaft 102.

The rim 105 comprises a first annular portion 105.1 that protrudes from the disc 106 and facing the hub 104, delimiting therewith a first annular recess 107.1 having one end closed by the disc 106 and one end that opens towards the leg 101. The rim 105 comprises a second annular portion 105.2 protruding from the disc 106 opposite the first annular portion 105.1, delimiting a second cylindrical recess 107.2 having one end closed by the disc 106 and an opposite open end. The second recess 107.2 communicates with the inner volume of the shaft 102.

According to the invention, the wheels 103 are each equipped with a friction braking device accommodated in the first recess 107.1 and a magnetic braking device accommodated in the second recess 107.2.

The friction braking device comprises elements that are able to rotate, or rotors 1, and elements that are not able to rotate, or stators 2.

More precisely, in this case, the stators 2 and the rotors 1 are in the form of disc components, coaxial with the wheel 103, and therefore having central axes that coincide with the axis of rotation of the wheel 103. The stators 2 and the rotors 1 are arranged in alternation and have main faces that face each other and are parallel to each other so as to be able to be pressed against each other and provide friction braking. The stators 2 are constrained to rotate with the shaft 102 and with the leg of the landing gear 101, in this instance by means of a torque tube 3 secured to a ring 111 secured to the shaft 102, whereas the rotors 1 are engaged, in a manner that is known per se, on ribs secured to the first annular portion 105.1 of the rim 105 of the wheel 103 to constrain the rotors 1 in rotation to the wheel 103 while guiding it in translation parallel to the axis of rotation of the wheel 103.

The torque tube 3 is provided with ribs to form slides allowing each of the stators 2 to slide without rotation on the torque tube 3 in such a way that it is possible to press the stack of disc components thus formed by the stators 2 and the rotors 1 and provide a braking force for the wheel 103. The pressing force of the stack of discs is applied by actuators 4 that are secured to the ring 111 and can be controlled by the pilot of the aeroplane, in a manner that is known per se, in order to move the stators 2 so as to be able to press or release the stack of discs and apply, modulate or interrupt the braking force on the wheel 103. The friction braking device is known per se and shall not be described in further detail here.

The magnetic braking device comprises a rotor 5 and a stator 6.

The rotor 5 comprises a sleeve 5.1 engaged in the second annular portion 105.2 of the rim 105, and a flange 5.2 that protrudes radially outwards from one end of said sleeve 5.1 opposite the flank 106 to extend in front of the flank secured to the annular portion 105.2 of the rim 105 and parallel to said flank. The rotor 5 is constrained to rotate with the annular portion 105.2, for example by means of screws fastening the flange 5.2 to the flank of the annular portion 105.2. The rotor is made from copper or any other electrically conductive material and is provided on the same side as the rim 105 with a heat shield 5.3 for limiting the transmission of heat towards the rim 105 and the tyre.

The stator 6 comprises a main support 6.1 in the shape of a disc having a main face, to the periphery of which a first ring of magnets 7 is fixed, extending facing the flange 5.2 of the rotor 5. A sleeve 6.2 with a circular section protrudes from said main face so that it can be engaged in the sleeve 5.1. The sleeve 6.2 has an external diameter smaller than an internal diameter of the sleeve 5.1 and has an external surface provided with a second ring of magnets 8 having an external diameter smaller than the internal diameter of the sleeve 5.1. The magnets are in this case made from rare earths; the support 6.1 and the sleeve 6.2 are preferably made from magnetic steel, or from a non-magnetic material.

In reference to FIG. 11, the first ring of magnets 7 comprises first magnets 11, 13 that have a first magnetization vector substantially perpendicular to the main face of the support 6.1 and that are separated in pairs by a second magnet 12, 14 having a second magnetization vector substantially perpendicular to the first magnetization vectors of the two first magnets 11, 13 between which the second magnet 12, 14 is located. It should be noted that the magnetization vector indicates the direction of the magnetic field generated by a magnet and extends, in the magnet, from the south pole to the north pole. More precisely, the magnets 11, 12, 13, 14 are in the shape of angular sectors and have a length measured in a radial direction of the stator 2 and an average width measured in a locally tangential direction of the stator 2 (i.e., perpendicular to the direction of the length) halfway along said length. The lengths and widths are measured in directions locally parallel to the main surface of the support 6.1.

The magnets 11, 12, 13, 14 are arranged in a Halbach array, alternating in the circumferential direction of the ring of magnets 7 (and therefore of the support 6.1) as follows: a magnet 11, a magnet 12, a magnet 13, a magnet 14, a magnet 11, a magnet 12, a magnet 13, a magnet 14 and so on. In this case:
each magnet 11 has its magnetization vector emanating from the radial face of the stator 6 (opposite the main face of the support 6.1) towards the flange 5.2 (its north pole emerges on said radial face);
each magnet 12 has its magnetization vector extending from the adjacent magnet 11 to the adjacent magnet 13;
each magnet 13 has its magnetization vector entering said radial face (its south pole emerges on said radial face); and
each magnet 14 has its magnetization vector extending from the adjacent magnet 11 towards the adjacent magnet 13.

It should be understood that the magnets 12, 14 arranged to each side of a given magnet 11 have their magnetization vector oriented in opposing directions.

Preferably, according to one advantageous version of the invention, the magnets 11, 12, 13, 14 have widths such that the first magnets 11, 13 are spaced apart in pairs by a first distance (equal to the width of the second magnets) less than a second distance (equal to the width of the first magnets) separating the second magnets 12, 14 in pairs. The best results are obtained when the width of the second magnets 12, 14 is approximately 70% that of the first magnets 11, 13.

The magnets 11, 12, 13, 14 are identical in length. It should be understood that the magnets 12, 14 occupy less of the surface area of the main face than the magnets 11, 13.

The Halbach array arrangement of the magnets 11, 12, 13, 14 helps optimize and concentrate the magnetic flux produced by the magnets 11, 13 by reducing the return path of the magnetic flux that passes through the magnets 12, 14 and not through the support, the weight of which may be reduced because it does not need to perform a magnetic flux conduction function.

In continuing reference to FIG. 11, the magnets of the second ring of magnets 8 are in the form of annular sectors positioned adjacent to one another around the sleeve 6.2 with the same alternation as those of the first ring 7 to form a Halbach array around the circumference of the sleeve 6.2. Therefore, there are first magnets 21, 23 that each have a first magnetization vector extending along a local radius (direction locally normal to the external surface of the sleeve 6.2 facing the magnet 21, 23 in question) and that are separated in pairs by a second magnet 22, 24 having a second magnetization vector substantially tangential to the external surface of the sleeve 6.2 and contained in a plane perpendicular to the central axis of the sleeve 6.2.

The magnets 21, 22, 23, 24 are positioned adjacent to one another by their straight longitudinal edges in a Halbach array, alternating in the circumferential direction of the sleeve 6.2 as follows: a magnet 21, a magnet 22, a magnet 23, a magnet 24, a magnet 21, a magnet 22, a magnet 23, a magnet 24 and so on. In this case:
each magnet 21 has its magnetization vector emanating from the external cylindrical surface of the stator 6 towards the internal surface of the sleeve 5.1 (its north pole emerges on this external cylindrical surface);
each magnet 22 has its magnetization vector extending from the adjacent magnet 21 towards the adjacent magnet 23;
each magnet 23 has its magnetization vector entering the external cylindrical surface of the stator 6 (its south pole emerges on the external cylindrical surface of the stator 6); and
each magnet 24 has its magnetization vector extending from the adjacent magnet 21 towards the adjacent magnet 23;

It should be understood that the magnets 22, 24 arranged to each side of a given magnet 21 have their magnetization vectors oriented in opposing directions.

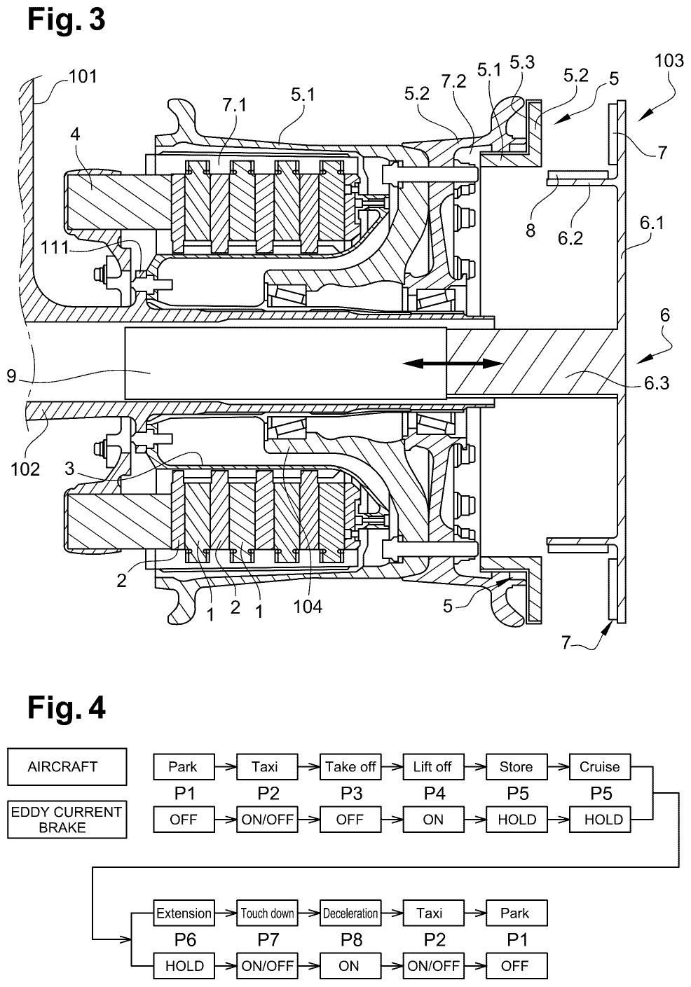

The stator 6 comprises a manoeuvring rod 6.3 slidingly engaged in the shaft 2 (the manoeuvring rod 6.3 is constrained to rotate with the shaft 2, for example by a rib/groove system) and mechanically linked to a linear electromechanical actuator 9 accommodated in the shaft 2 and connected to the electronic control unit 110. The linear electromechanical actuator 9 is arranged to move the stator 6 axially between:
a first axial position or braking position (shown in FIG. 2); and
a second axial position or freely rotating position (shown in FIG. 3).

In the first axial position, the sleeve 6.2 is engaged in the sleeve 5.1 (the entire length of the magnets 21, 22, 23, 24 faces the internal surface of the sleeve 5.1 and they are separated from it by a radial air gap) and the support 6.1 is brought closer to the flange 5.2 (the magnets 11, 12, 13, 14 are separated from the main surface of the flange 5.2 opposite the rim 105 by a first axial air gap). The first ring of magnets 7 is capable of generating eddy currents in the flange 5.2 of the rotor 5 when the stator 6 is in the first axial position in relation to the rotor 5 and the rotor 5 pivots in relation to the stator 6. The second ring of magnets 8 is capable of generating eddy currents in the sleeve 5.1 of the rotor 5 when the stator 6 is in its first axial position in relation to the rotor 5 and the rotor 5 pivots in relation to the stator 6. The eddy currents generated are likely to produce a significant braking force on the rotor 5 depending on the speed of rotation of the rotor 5 in relation to the stator 6.

In the second axial position, the sleeve 6.2 is disengaged from the sleeve 5.1 (the magnets 21, 22, 23, 24 no longer face the internal surface of the sleeve 5.1) and the support 6.1 is moved away from the flange 5.2 (the magnets 11, 12, 13, 14 are separated from the main surface of the flange 5.2 opposite the rim 105 by a second axial air gap greater than the first axial air gap). In this second position, the first ring of magnets 7 and the second ring of magnets 8 are no longer capable of generating eddy currents in the rotor 5 that are likely to produce a significant braking force on the wheel when the rotor 5 pivots in relation to the stator 6, irrespective of its speed of rotation.

It should be understood that, in order to induce braking, the linear electromechanical actuator 9 is controlled to bring the stator 6 into the first axial position and that, in order to stop braking, the linear electromechanical actuator 9 is controlled to bring the stator 6 into the second axial position, in which position the magnets do not allow sufficient eddy currents to be generated in the rotor 5 to induce braking of the rotor 5. Between the two above positions, the magnetic braking device may produce intermediate braking torque values. It should be noted that, below a certain speed of rotation of the rotor 5, the braking torque is negligible, irrespective of the position of the stator 6.

In reference to FIG. 4, the electronic control unit 110 is arranged to control the actuators 4, 9 and 109 as follows:
when the aeroplane is parked on the ground (phase P1), the landing gear 101 being in the deployed position, the linear electromechanical actuator 9 is not powered and keeps the stator 6 in the second axial position, and the actuator 4 presses the stack of disc components;
for taxiing manoeuvres (phase P2), the magnetic brake is used as a speed limiter, the actuator 4 being used if necessary if the braking force provided by the magnetic braking device is insufficient;
at take-off (phase P3), the linear electromechanical actuator 9 is not powered and keeps the stator 6 in the second axial position;
once the aeroplane has left the ground, the actuator 109 brings the landing gear 101 to the stowed position (phase P4) and the linear electromechanical actuator 9 is powered to bring the stator 6 to the first axial position to reduce the space requirement of the rolling device around the wheel 103;
during cruising flight (phase P5), the linear electromechanical actuator 9 is powered to keep the stator 6 in the first axial position;
for landing, the actuator 109 brings the landing gear 101 to the deployed position (phase P6) and the linear electromechanical actuator 9 brings the stator 6 to the second axial position to authorize rotation of the wheel;
at the instant contact is made with the ground (phase P7), and then during deceleration the linear electromechanical actuator 9 is powered to bring the stator 6 to the first axial position and the actuator 4 controlled depending on the braking requirements to bring the aeroplane to taxiing speed; and
for taxiing (P2) and parking (P1), see above.

Keeping the stator 6 in the braking position helps reduce the space requirement of the wheel 103 and therefore the space required to stow it in the hold 108.

Elements that are identical or similar to those described above have been given the same reference numbers in the figures and hereinafter in the description relating to the variants and the second and third embodiments.

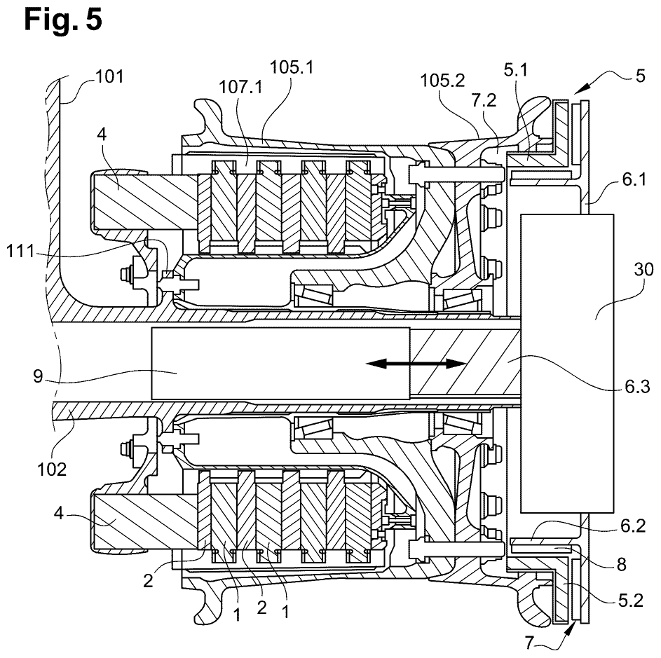

In the variant of FIG. 5, the stator 6 is equipped with a fan with reference number 30 for cooling the braking devices. Such a fan is known per se.

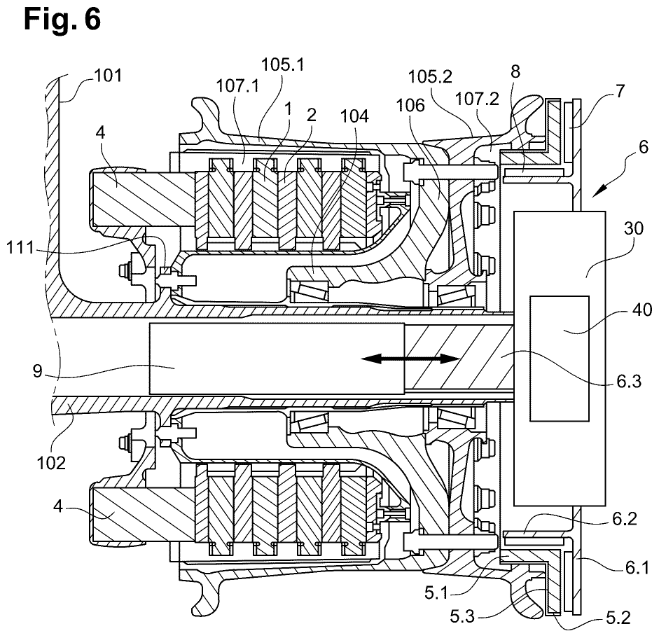

In the variant of FIG. 6, in addition to the fan 30, the stator 6 is equipped with a tachometer 40 or any other device for measuring the speed of rotation of the wheel 103. Such a tachometer is known per se.

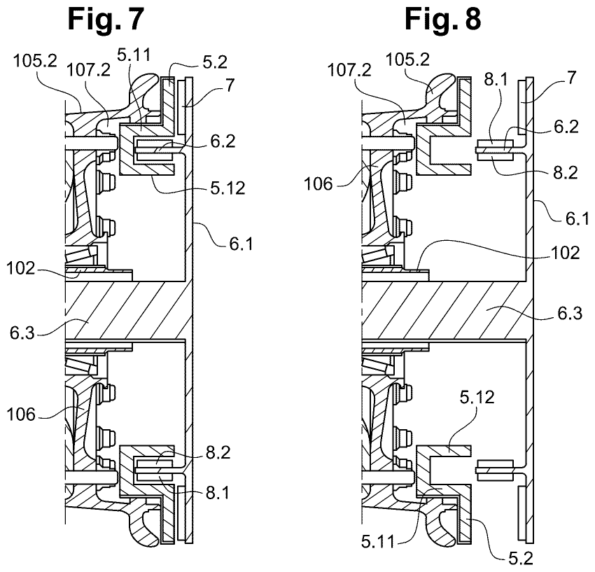

In reference to FIGS. 7 and 8 and according to the second embodiment, the rotor 5 comprises an outer sleeve 5.11 and an inner sleeve 5.12 that together delimit a channel having a bottom partition joining the outer sleeve 5.11 and the inner sleeve 5.12.

The sleeve 6.2 is received in the channel and carries two rings of magnets:
one ring of magnets 8.1 mounted on the external surface of the sleeve 6.2 to face the outer sleeve 5.11; and
one ring of magnets 8.2 mounted on the internal surface of the sleeve 6.2 to face the inner sleeve 5.12.

The rings of magnets 8.1, 8.2 are constituted like the ring of magnets 8 of the first embodiment.

The internal surface of the outer sleeve 5.11 and the external surface of the ring of magnets 8.1 form a first pair of cylindrical surfaces, coaxial with the shaft 102, engaged with each other when the stator 6 is in the braking position and disengaged from each other when the stator 6 is in the freely rotating position.

The external surface of the inner sleeve 5.12 and the internal surface of the ring of magnets 8.2 form a second pair of cylindrical surfaces, coaxial with the shaft 102, engaged with each other when the stator 6 is in the braking position and disengaged from each other when the stator 6 is in the freely rotating position.

These two pairs of cylindrical surfaces and the pair of radial surfaces formed by the main surface of the flange 5.2 and the surface of the ring of magnets 7 facing it each allow magnetic flux to pass through.

It should be understood that this arrangement makes it possible to increase the eddy currents generated in the rotor 5.

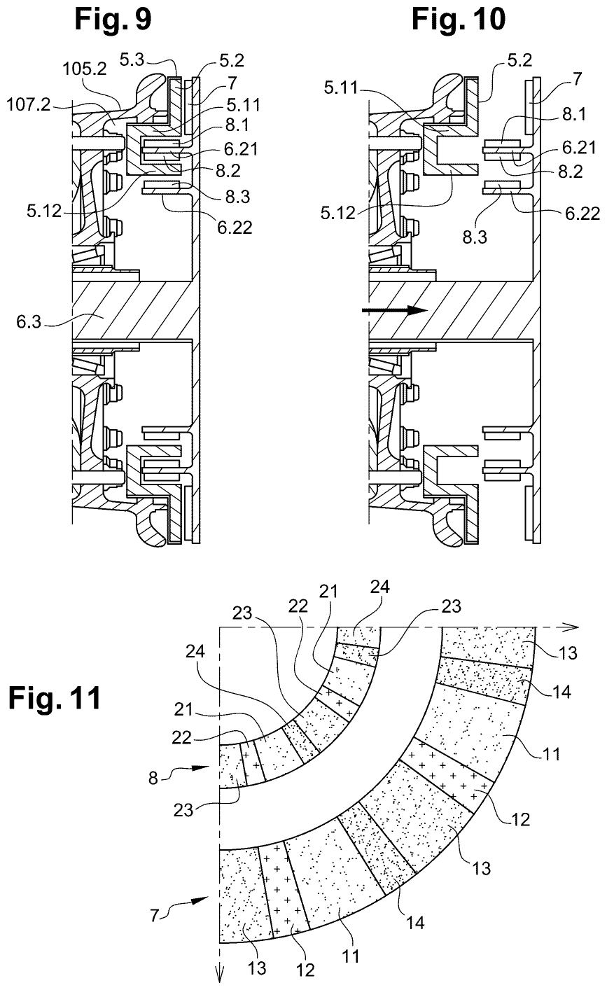

In reference to FIGS. 9 and 10 and according to the third embodiment, the rotor is of the same shape as in the second embodiment and the sleeve 6.2 carries two rings of magnets 8.1, 8.2 as before.

The stator 6 comprises two sleeves instead of a single sleeve 6.1, i.e., an outer sleeve 6.21 and an inner sleeve 6.22, such that the inner sleeve 5.12 can be engaged between the sleeves 6.21, 6.22. The outer sleeve 6.21 has an external surface that faces the outer sleeve 5.11 and that is provided with a ring of magnets 8.1. The outer sleeve 6.21 has an internal surface that faces the inner sleeve 5.12 and that is provided with a ring of magnets 8.2. The inner sleeve 6.22 has an external surface that faces the inner sleeve 5.12 and that is provided with a ring of magnets 8.3.

The rings of magnets 8.1, 8.2, 8.3 are constituted like the ring of magnets 8 of the first embodiment.

The internal surface of the outer sleeve 5.11 and the external surface of the ring of magnets 8.1 form a first pair of cylindrical surfaces, coaxial with the shaft 102, engaged with each other when the stator 6 is in the braking position and disengaged from each other when the stator 6 is in the freely rotating position.

The external surface of the inner sleeve 5.12 and the internal surface of the ring of magnets 8.2 form a second pair of cylindrical surfaces, coaxial with the shaft 102, engaged with each other when the stator 6 is in the braking position and disengaged from each other when the stator 6 is in the freely rotating position.

The internal surface of the inner sleeve 5.12 and the external surface of the ring of magnets 8.3 form a third pair of cylindrical surfaces, coaxial with the shaft 102, engaged with each other when the stator 6 is in the braking position and disengaged from each other when the stator 6 is in the freely rotating position.

These three pairs of cylindrical surfaces and the pair of radial surfaces formed by the main surface of the flange 5.2 and the surface of the ring of magnets 7 facing it each allow magnetic flux to pass through.

It should be understood that this arrangement makes it possible to further increase the eddy currents generated in the rotor 5.

The thickness of the inner sleeve 5.12 is preferably such that a skin effect (also referred to as Kelvin effect) is generated from each ring of magnets 8.2, 8.3 over more than half the thickness of the inner flank 5.12 at least over a range of possible relative speeds of the rotor 5 in relation to the stator 6. The eddy currents generated from the two rings of magnets 8.2, 8.3 will then circulate in the central portion of the inner flank 5.12, which increases the braking torque. This produces a “superimposed skin effect”, the thickness of the inner sleeve 5.12 being sufficiently small to achieve this effect while satisfying the thermal and mechanical constraints. In one example, this effect improves performance by approximately 60%.

Naturally, the invention is not limited to the described embodiments, but covers any variant that falls within the scope of the invention as defined by the claims.

In particular, the structure of the device may be different to that described.

The rotor may be moved axially instead of the stator to activate or deactivate magnetic braking.

The magnets may be carried by the rotor instead of the stator.

The shape, arrangement and dimensions of the magnets may be different to those described. For example, the magnets 11, 12, 13, 14 are all of the same dimensions or, conversely, the first magnets 11, 13 represent approximately 70% of the surface area of the element that carries them, but this is not mandatory. The magnets may or may not have identical lengths and/or widths, and may or may not be positioned symmetrically on a circle passing through the geometric centre of the north poles of the magnets 11 and the south poles of the magnets 13.

Using a Halbach array is not mandatory.

The number of rotors and/or the number of stators may be different from those mentioned.

Although in the described embodiments the rotor and the stator are arranged to benefit from an axial flux (passing through the pair of radial surfaces) and a radial flux (passing through the pair or pairs of axial surfaces), it is possible to arrange the rotor and the stator to have only an axial flux or a radial flux.

The magnetic braking device may use permanent magnets and electromagnets powered via cables passing through the shaft 102 to inhibit or reinforce the magnetic field produced by the permanent magnets, the stator then being stationary in translation. A braking device comprising only electromagnets may also be envisaged.

The actuators may generally be hydraulic or electric.

“Linear actuator” should be understood to mean any actuator whose movable element moves in translation. Therefore, an actuator comprising a motor driving a worm screw on which a nut is mounted that moves parallel to the worm screw is a linear actuator.

The actuators of the friction may brake be electromechanical. Each electromechanical actuator comprises an electric motor and a pusher that can be moved by the electric motor to press the stack of discs. The electromechanical actuator is thus intended to produce a controlled braking force on the stack of discs. One method for controlling braking devices is known from document FR-A-2953196, for example.

The invention can be used on any type of vehicle comprising rotating rolling elements.

1. A rolling device for a vehicle, comprising a leg provided with a shaft and a wheel having a hub mounted to pivot on the shaft, the wheel comprising a rim that is linked to the hub by a disc to extend coaxially with the hub, the rim comprising a first annular portion that protrudes from the disc and facing the hub, delimiting therewith a first annular recess having one end closed by the disc and one end that opens towards the leg to receive a friction braking device, the rim comprising a second annular portion protruding from the disc opposite the first annular portion delimiting a second recess having one end closed by the disc and an opposite open end, characterized in that a magnetic braking device is mounted in the second recess, and comprises:
a first element and a second element that has a surface facing a surface of the first element and is able to rotate in relation to the first element, one of the first or second element being constrained to rotate with the shaft and one of the first or second element being constrained to rotate with the wheel; and
a control member of the magnetic braking device extending at least partially into the shaft.

2. The rolling device according to claim 1, in which the first element is made from an electrically conductive material and the second element is provided with permanent magnets carrying a plurality of magnets in order to generate, through the facing surfaces, eddy currents in the first element when the first element rotates in relation to the second element.

3. The rolling device according to claim 2, in which the control member comprises a linear actuator linked to the first element to move the first element axially between a braking position in which the facing surfaces are brought closer together and a freely rotating position in which the facing surfaces are moved apart.

4. The rolling device according to claim 3, in which the facing surfaces comprise two radial surfaces separated by a first axial air gap when the first element is in the braking position and by a second axial air gap when the first element is in the freely rotating position.

5. A The rolling device according to claim 3, in which the facing surfaces comprise at least one first pair of cylindrical surfaces, coaxial with the shaft, engaged with each other when the first element is in the braking position and disengaged from each other when the first element is in the freely rotating position.

6. The rolling device according to claim 5, in which the facing surfaces comprise at least one second pair of cylindrical surfaces, coaxial with the shaft, engaged with each other when the first element is in the braking position and disengaged from each other when the first element is in the freely rotating position.

7. The rolling device according to claim 6, in which the facing surfaces comprise at least one third pair of cylindrical surfaces, co-axial with the shaft, engaged with each other when the first element is in the braking position and disengaged from each other when the first element is in the freely rotating position.

8. The rolling device according to claim 1, in which the first element can be moved between a braking position in which the facing surfaces are brought closer together and a freely rotating position in which the facing surfaces are moved apart, and the first element in the braking position is closer to the leg than in the freely rotating position.

9. A The rolling device according to claim 1, in which the first element carries a cooling fan.

10. The rolling device according to claim 1, in which the first element carries a tachometer.

11. The rolling device according to claim 1, forming part of an aircraft landing gear.

12. An aircraft comprising a structure to which there is fastened at least one rolling device according to claim 1 and an actuator for moving the rolling device between a deployed position in which the rolling device protrudes under the structure and a stowed position in which the rolling device is received in a hold of the structure.

13. The aircraft according to claim 12, in which the first element of the rolling device can be moved between a braking position in which the facing surfaces are brought closer together and a freely rotating position in which the facing surfaces are moved apart, and the first element in the braking position is closer to the leg than in the freely rotating position, and which comprises an actuator for moving the first element, this actuator being connected to an electronic control unit programmed to bring the first element to the braking position when the rolling de-vice is brought into the hold.
